(19) United States
(12) Patent Application Publication
(10) Pub. No.: US 2015/0241982 A1
(43) Pub. Date: Aug. 27, 2015

(54) APPARATUS AND METHOD FOR PROCESSING USER INPUT

(71) Applicant: SAMSUNG ELECTRONICS CO., LTD., Suwon-si (KR)

(72) Inventors: Byuk-sun KIM, Seoul (KR); Sung-gook KIM, Seoul (KR); Min-jin KIM, Pyeongtaek-si (KR); Yong-deok KIM, Anyang-si (KR); Chang-soo NOH, Yongin-si (KR)

(73) Assignee: SAMSUNG ELECTRONICS CO., LTD., Suwon-si (KR)

(21) Appl. No.: 14/570,588

(22) Filed: Dec. 15, 2014

(30) Foreign Application Priority Data
Feb. 27, 2014 (KR) 10-2014-0023322

(51) Int. Cl. G06F 3/01; G06F 3/0488

(52) U.S. Cl. CPC G06F 3/017; G06F 3/04883

(57) ABSTRACT

A method and apparatus for processing a gesture input of a display apparatus is provided. The method includes setting a gesture input mode based on an operational situation of the display apparatus, displaying information about the set gesture input mode on a screen of the display apparatus, and in response to receiving an input that corresponds to the set gesture input mode, performing a control operation with respect to the screen.

### CROSS-REFERENCE TO RELATED APPLICATION(S)

This application claims priority from Korean Patent Application No. 10-2014-0023322, filed on Feb. 27, 2014 in the Korean Intellectual Property Office, the entire disclosure of which is incorporated herein by reference for all purposes.

### BACKGROUND

1. Field

Apparatuses and methods consistent with exemplary embodiments relate to a display apparatus, and more particularly, to a display apparatus and method for receiving a user gesture that can be input via various input devices of the display apparatus.

2. Description of Related Art

Related art display apparatuses that receive a user input typically support a four-direction input that is transmitted from a remote controller. Recently, display apparatuses have been designed to receive additional inputs such as through a mouse, a touchpad, vocal commands, and the like, in addition to the four-direction input. The input devices may be used for various functions such as enlargement, reduction, rotation, and the like, of an object on a screen. In this regard, when a remote controller is used for these functions, the usability of the remote controller is limited. Therefore, a method of inputting a gesture by a user's hand has been introduced in an effort to more easily control an object on a screen.

FIG. 1 illustrates an example of a user gesture input for rotating an object 11 that is displayed on a screen of a related display apparatus. In response to rotation of both fists of a user in one direction (clockwise or counterclockwise) while the fists are spaced apart by a predetermined distance, the object 11 rotates as illustrated in (A) of FIG. 1. In addition, in response to both fists of the user being moved away from each other, the object 11 is enlarged as illustrated in (B) of FIG. 1.

However, because the user gesture may be input using various input devices and because functions of a display apparatus are diversified, a user frequently has difficulty in recognizing an optimum input device or input method for performing a corresponding function. Accordingly, there is a desire for a function that can guide a user and provide information about various input devices based on an operational situation of the display apparatus.

### SUMMARY

Exemplary embodiments overcome the above disadvantages and other disadvantages not described above. Also, an exemplary embodiment is not required to overcome the disadvantages described above, and an exemplary embodiment may not overcome any of the problems described above.

One or more exemplary embodiments provide to a display apparatus which may help guide a user by providing usage information about various input devices according to an operation status of the display apparatus, thereby enhancing user convenience.

According to an aspect of an exemplary embodiment, there is provided a method of processing a gesture input that is input to a display apparatus, the method including setting a gesture input mode based on an operational situation of the display apparatus, displaying information about the set gesture input mode on a screen of the display apparatus; and in response to receiving an input that corresponds to the set gesture input mode, performing a control operation with respect to the screen.

The setting of the gesture input mode may include recommending a gesture input mode according to the operational situation of the display apparatus and displaying the recommended gesture input mode on the screen, and in response to selection of the recommended gesture input mode being input, setting the recommended gesture input mode as the gesture input mode.

The setting of the gesture input mode may include, in response to a user input being performed via the set gesture input mode, displaying information about another available gesture input mode, and setting the gesture input mode as the other available gesture input mode in response to selection of the other available gesture input mode being input.

The method may further include displaying information indicating that the gesture input mode is changed, in response to the gesture input mode being changed.

The method may further include, in response to a user input for a different gesture input mode from the set gesture mode being received, determining whether the different gesture input mode is available, and converting the gesture input mode into the different gesture input mode.

The method may further include displaying a recommended movement path of an input device according to the received user input on the screen.

The outputting may include, in response to the set gesture input mode being a writing input mode, analyzing the received input, converting the received input into a character, and displaying the converted character.

The outputting may include, in response to the set gesture input mode being an operational control mode, analyzing the received input, converting the received input into a control command, and controlling the display apparatus according to the converted control command.

The operational situation of the display apparatus may be based on an application that is being executed by the display apparatus.

According to an aspect of another exemplary embodiment, there is provided a non-transitory computer readable medium for recording thereon a program for executing the method.

According to an aspect of another exemplary embodiment, there is provided a display apparatus including a display, an input unit configured to receive a user input, and a controller configured to set a gesture input mode according to an operational situation of the display apparatus, display information about the set gesture input mode on a screen of the display, and, in response to receiving an input that corresponds to the set gesture input mode, perform a control operation with respect to the screen.

The controller may be configured to recommend a gesture input mode according to the operational situation of the display apparatus and display the recommended gesture input mode, and in response to selection of the recommended gesture input mode being input, set the recommended gesture input mode as the gesture input mode.

In response to a user input being performed via the set gesture input mode, the controller may be configured to display information about another available gesture input mode on the screen, and set the gesture input mode as the other gesture input mode in response to selection of the other gesture input mode being input.

The controller may be configured to display information indicating that the gesture input mode is changed on the screen, in response to the gesture input mode being changed.

In response to an input for a different gesture input mode from the set gesture input mode being received, the controller may be configured to determine if the different gesture input mode is available, and convert the gesture input mode of the display apparatus into the different gesture input mode.

The controller may be configured to display a recommended movement path of an input device according to the received user input.

In response to the set gesture input mode being a writing input mode, the controller may be configured to analyze the received input, convert the received input into a character, and display the converted character on the screen.

In response to the set gesture input mode being an operational control mode, the controller may be configured to analyze the received input, convert the received input into a control command, and control the display apparatus according to the converted control command.

The operational situation of the display apparatus may be based on an application that is being executed by the display apparatus.

According to an aspect of another exemplary embodiment, there is provided a display apparatus configured to receive user input through a plurality of input devices, the display apparatus including a controller configured to determine at least one input device, from among the plurality of input devices, as an input device for user interaction with an application executed by the display apparatus, and a display configured to display information identifying the at least one input device determined by the controller during execution of the application.

The plurality of input devices may include at least one of a remote controller, a keyboard, a camera, a microphone, a touch pad, and a mouse.

The controller may be configured to determine the at least one input device based on the application being executed by the display apparatus.

The controller may be configured to determine a plurality of input devices as input devices for user interaction with the application, and the display is configured to display information identifying the plurality of input devices.

The controller may be further configured to determine an input device from among the determined plurality of input devices as a priority input device, and the display may be configured to display information identifying the priority of the priority input device.

In response to the user inputting a command through a first input device, the controller may be further configured to recommend a second input device as a more optimum input device for inputting the command.

### BRIEF DESCRIPTION OF THE DRAWINGS

The above and/or other aspects will be more apparent by describing certain exemplary embodiments with reference to the accompanying drawings, in which:

FIG. 1 is a diagram illustrating a related user gesture input for rotating an object on a display;

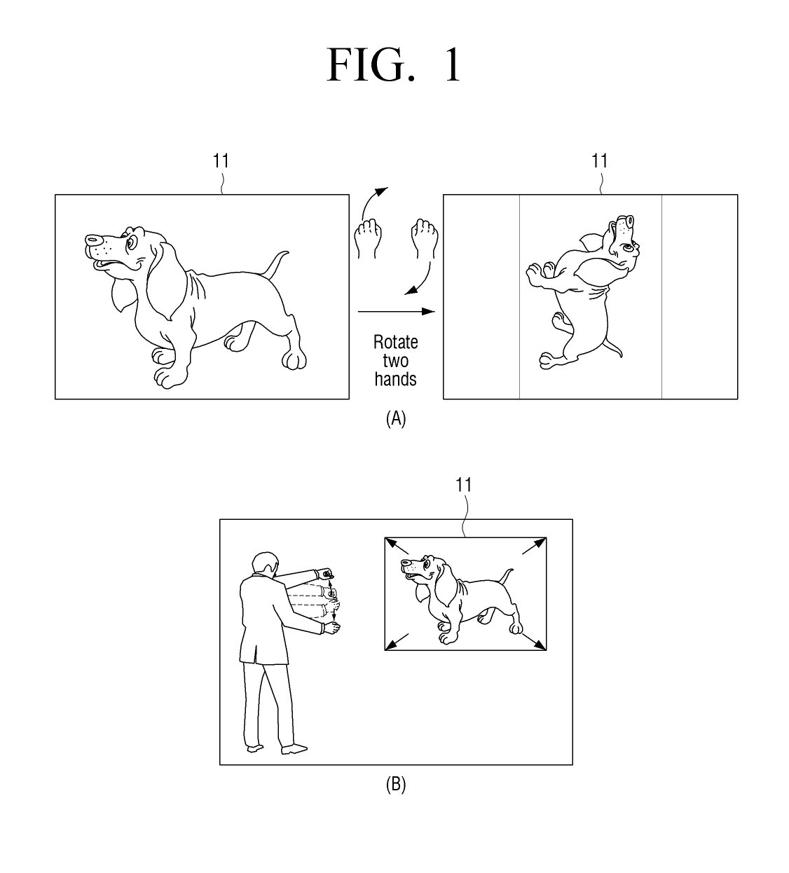

FIG. 2 is a diagram illustrating a display system according to an exemplary embodiment;

FIG. 3 is a block diagram illustrating a display apparatus according to an exemplary embodiment;

FIG. 4 is a diagram illustrating the display apparatus displaying information about a set gesture input mode according to an exemplary embodiment;

FIG. 5 is a diagram illustrating a display of an image when a plurality of input modes are available according to an exemplary embodiment;

FIG. 6A is a diagram illustrating the display apparatus recommending another input mode that is available to a user according to an exemplary embodiment;

FIG. 6B is a diagram of another gesture input mode that is available to a user according to an exemplary embodiment;

FIG. 7 is a diagram illustrating the display apparatus indicating a change in an input mode according to an exemplary embodiment;

FIG. 8 is a table illustrating methods and operations of possible gesture inputs according to an exemplary embodiment;

FIG. 9A illustrates an input that is received according to a remote controller touch gesture input mode while a user gesture input mode is set according to an exemplary embodiment;

FIG. 9B illustrates an input that is received according to a remote controller movement gesture input mode while a user gesture input mode is set according to an exemplary embodiment;

FIG. 10A illustrates the display apparatus displaying a gesture path according to an exemplary embodiment;

FIG. 10B illustrates the display apparatus displaying a remote controller movement gesture path according to an exemplary embodiment;

FIG. 11 is a diagram illustrating an operation of a display apparatus that is set to a writing input mode according to an exemplary embodiment;

FIG. 12 is a diagram illustrating a game displayed by the display apparatus that is interacted with by a user gesture input through a touch pad according to an exemplary embodiment; and

FIG. 13 is a flowchart of a gesture input processing method according to various exemplary embodiments.

### DETAILED DESCRIPTION

Certain exemplary embodiments will now be described in greater detail with reference to the accompanying drawings. Throughout the drawings and the detailed description, unless otherwise described or provided, the same drawing reference numerals will be understood to refer to the same elements, features, and structures. The drawings may not be to scale, and the relative size, proportions, and depiction of elements in the drawings may be exaggerated for clarity, illustration, and convenience.

The following detailed description is provided to assist the reader in gaining a comprehensive understanding of the methods, apparatuses, and/or systems described herein. However, various changes, modifications, and equivalents of the methods, apparatuses and/or systems described herein will be apparent to one of ordinary skill in the art. The progression of processing steps and/or operations described is an example; however, the sequence of and/or operations is not limited to that set forth herein and may be changed as is known in the art, with the exception of steps and/or operations necessarily occurring in a certain order. Also, descriptions of functions and constructions that are well known to one of ordinary skill in the art may be omitted for increased clarity and conciseness.

The features described herein may be embodied in different forms, and are not to be construed as being limited to the examples described herein. Rather, the examples described herein have been provided so that this disclosure will be thorough and complete, and will convey the full scope of the disclosure to one of ordinary skill in the art

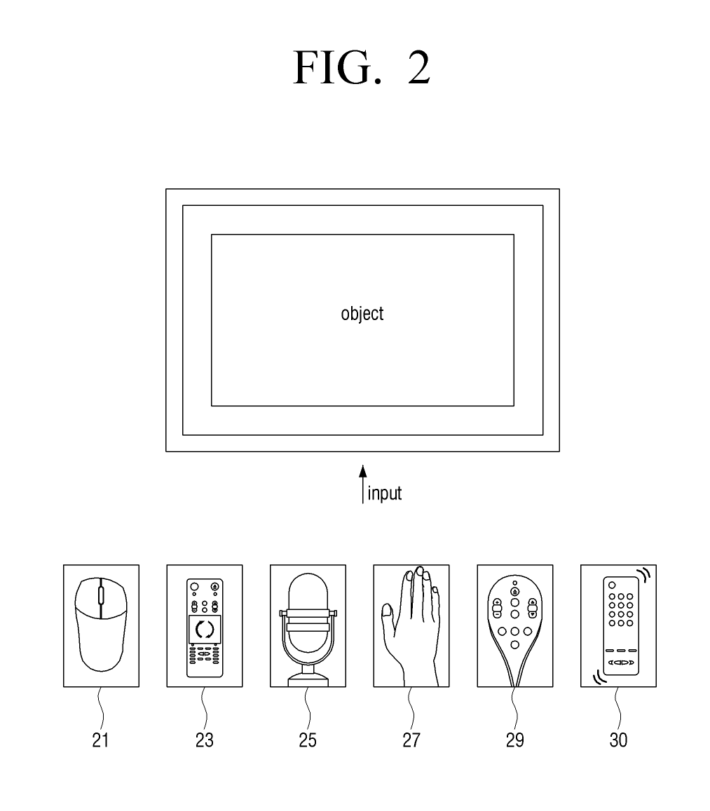

FIG. 2 is a diagram illustrating a display system according to an exemplary embodiment.

As illustrated in FIG. 2, the display system may be used to perform input on a display apparatus 100 using a plurality of input devices 21 through 29. For example, mouse 21 is an input device that may be used to move a mouse pointer and select an object on the screen. Remote controllers 23 and 29 may generate various control commands and transmit the control commands to the display apparatus 100. In this example, the remote controller 23 includes a touch pad. Accordingly, the remote controller 23 may detect a user gesture input on the touch pad, and may transmit the user gesture input to the display apparatus 100. In addition, a control command may be generated by button manipulation performed by a user using both remote controllers 23 and 29. A remote controller 30 includes a moving sensor that may detect movement of the remote controller 30 and transmit information about the movement to the display apparatus 100. Accordingly, a user may input commands by simply moving the remote controller 30 in various ways. A microphone 25 may detect sounds and may transmit the sounds to the display apparatus 100. The display apparatus 100 may recognize voice commands received from the microphone 25 and convert the voice commands into a corresponding control command.

Without the aforementioned input devices, it may also be possible to input a user gesture using a user hand or body 27. For example, the display apparatus 100 may include a device for photographing a user hand such as a camera. Accordingly, the display apparatus 100 may analyze one or more images capture by the camera and determine a change in the hand operation to identify a control command.

The display apparatus 100 may receive a user input from the aforementioned input devices and perform a corresponding output. For example, the display apparatus 100 may output an object, receive a user input for manipulating the object, and perform corresponding output. In an example in which a moving picture is being output to an entire portion of a screen size, the display apparatus 100 may receive a user input for adjustment of the output size of the moving picture. In response to a user gesture being input for reducing an image size, the display apparatus 100 may output the moving picture on only a partial region of the entire screen.

It should be appreciated that a type of the object that is displayed on a screen corresponding to the display apparatus is not limited. For example, the object may be at least one of image content, an application, game content, a thumbnail image, a widget, an item, a menu, and the like.

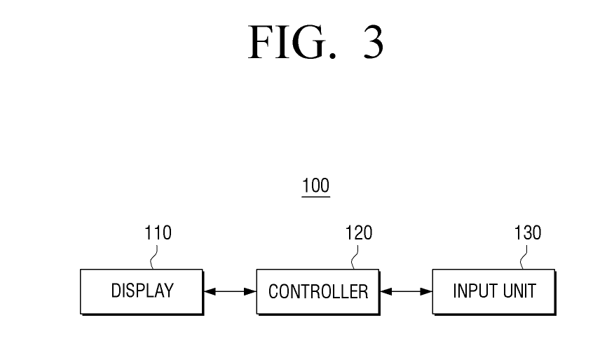

FIG. 3 is a block diagram illustrating a display apparatus 100 according to an exemplary embodiment.

Referring to FIG. 3, the display apparatus 100 may be a terminal, for example, a digital television, a tablet, a personal computer (PC), a portable multimedia player (PMP), a personal digital assistant (PDA), a smart phone, a cellular phone, a digital picture frame, a digital signage, a kiosk, and the like. As another example, the display apparatus 100 may be a set-top box which connects to a terminal. In the example of FIG. 3, the display apparatus includes a display 110, a controller 120, and an input unit 130.

The display 110 may display an object on a screen. The display 110 may output an image corresponding to a user input based on a control signal from the controller 120 and output information about an input mode. The display 110 may include various display panels. For example, the display 110 may include an organic light emitting diode (OLED), a liquid crystal display (LCD) panel, a plasma display panel (PDP), a vacuum fluorescent display (VFD), a field emission display (FED), an electro luminescence display (ELD), and the like. The display panel may be designed as a light emission-type display panel. In some aspects, the display may be designed as a reflection-type display, such as E-ink, P-ink, photonic crystal, and the like. In addition, the display panel may be embodied as a flexible display, a transparent display, and the like. The display apparatus 100 may be embodied as a multi-display apparatus 100 including two or more display panels.

The input unit 130 may receive a user input. The input unit 130 may include an interface that receives a control signal, for example, from a remote controller, a microphone, a microphone, a mouse, and the like. The input unit 130 may also include an imaging device. In the case of a user gesture, an image may be captured by the imaging device included in the input unit 130.

Pre-processing, data conversion, and the like may be performed by each input device. As a result, raw data may be transmitted directly to the display apparatus 100, and data processing operations may be performed by the display apparatus 100, which may vary based on a method that is used to input the data.

The controller 120 may control an overall operation of the display apparatus 100. For example, the controller 120 may be or may include one or more processing devices. A processing device may be implemented using one or more general-purpose or special-purpose computers, such as, for example, a processor, a controller and an arithmetic logic unit, a digital signal processor, a microcomputer, a field-programmable array, a programmable logic unit, a microprocessor, or any other device capable of running software or executing instructions.

The controller 120 may set a predetermined gesture input mode according to an operational situation of the display apparatus 100. The operational situation refers to a situation in which a display apparatus displays an object and waits for a user input. For example, when a user uses a short message service (SMS), an SMS application may be executed and a graphical user interface (GUI) may be displayed. In this example, the predetermined input mode may be set. When a smart phone or a tablet personal computer (PC) performs input, the controller 120 may set the gesture input mode as a touch input mode. As another example, the controller may set the gesture input mode to a writing input mode. In this example, a drag input may be performed by a user for example using a mouse, and the user may perform character input for example using a keyboard.

There may be various input modes. For example, the input mode of the display apparatus 100 may include a user gesture input mode for inputting a gesture input by a user object such as a hand. The input mode may include a remote controller touch gesture input mode for receiving a touch gesture input via a touchpad of a remote controller. The input mode may include a remote controller movement gesture input mode for receiving a gesture input based on a movement of a remote controller detected by a moving sensor. As another example, the input mode may include a remote controller button input mode for receiving a control command generated by manipulating buttons of a remote controller.

In response to the display apparatus 100 being turned on, the controller 120 may set the input mode as a default input mode. In an example in which the display apparatus 100 is embodied as a digital television (DTV), a remote controller may be most often used. Accordingly, the default input mode may be set as a remote controller button input mode.

It is also possible for the display apparatus 100 to simultaneously support a plurality of different input modes. For example, in response to an application being executed by the display apparatus 100, it may be possible to perform user input via both a remote controller and a pointer device.

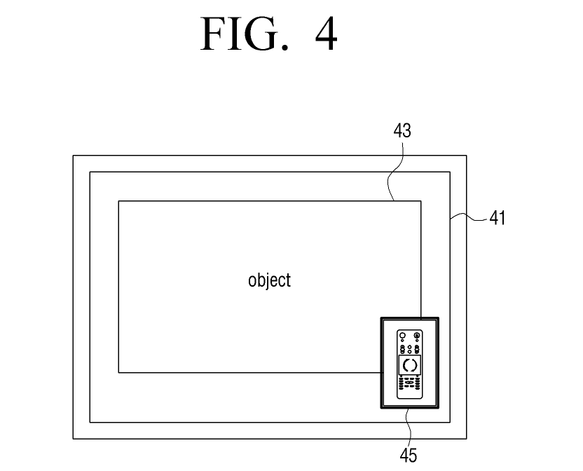

FIG. 4 is a diagram illustrating the display apparatus displaying information about a set user gesture input mode according to an exemplary embodiment. For example, because the display apparatus 100 described herein may provide multiple input modes, it is helpful to a user to notify the user of a currently set input mode.

Referring to FIG. 4, the controller 120 may control the display 110 to display information about a currently set input mode at a region of a screen. For example, when a currently set input mode is a remote controller touch gesture input mode, an icon corresponding to a touch gesture of a remote controller is displayed on a region 45 of the screen. In this example, a gesture is capable of being input to the display apparatus 100 via a touch pad of a remote controller. Accordingly, when an object 43 is displayed on a screen 41, the display apparatus 100 may display information indicating that it is possible to input a gesture via a remote controller, on a region 45 of the screen.

According to various aspects, different input devices in various input modes may be used to input commands, for example, a remote controller movement gesture input mode, a user gesture input mode, a mouse input mode, a keyboard input mode, a voice input mode, a pointer input mode, a remote controller touch gesture input mode, and the like. Information about the set or otherwise determined input mode or the input device may be displayed on a region of a screen. Although FIG. 4 illustrates an example in which an icon about an input mode is displayed, other identifiers may be displayed. For example, a character, a moving picture, and the like, which are not an icon may be displayed. It is also possible to display an input gesture shape. For example, a drag direction or shape may be displayed as arrow movement.

According to various aspects, the display apparatus 100 may support a plurality of input modes and may display information about the plurality of input modes. It should be appreciated that the number and type of the supported input modes may be changed according to an operational situation of the display apparatus 100. In this example, the operational situation may be based on an application that is selected by a user for execution by the display apparatus. For example, in response to a web browser being executed, although input via a mouse input mode, a user gesture input mode, a remote controller movement gesture input mode, and the like may be supported, the user gesture input mode may be inactivated while a user is writing an e-mail. In addition, there may be priority between a plurality of supported input modes and information about the priority may also be displayed.

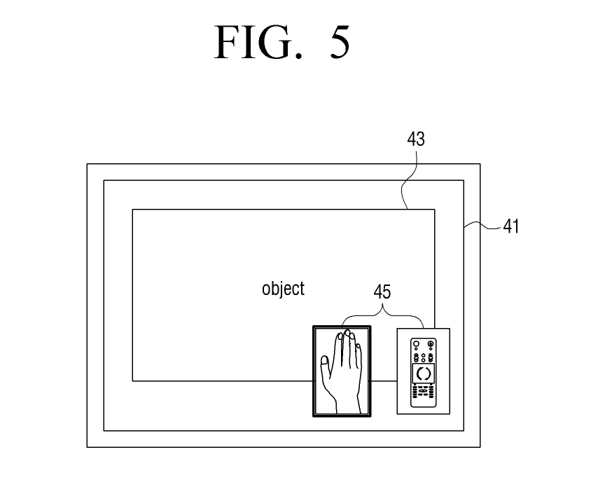

FIG. 5 is a diagram illustrating a display image of the display apparatus when a plurality of input modes are supported according to an exemplary embodiment.

Referring to FIG. 5, with regard to an object 43, an input via a user gesture and an input via a remote controller 45 are both possible in this example. In order to display information indicating there is priority for input via the user gesture, an icon corresponding to the user gesture input mode is highlighted as evidenced by the bold line around the icon. Accordingly, the user may convert an input mode via a remote controller or a user gesture input.

However, in this example, the controller 120 does not display information about an available input device, i.e., input mode information on one region of a screen. Instead, in this example the controller 120 may recommend an optimum input device based on an operational situation of the display apparatus 100. In this example, upon receiving a selection about the input mode that is recommended, the controller 120 may control the display apparatus 100 to set the input mode.

For example, if a plurality of input modes are available in a specific operational situation of the display apparatus 100, the controller 120 may determine that user convenience is low with one or more of the input modes, and may recommend an input mode with a higher or optimum user convenience. As one example, user convenience may be determined by a designer of the display apparatus 100. As another example, user convenience may be determined by a company providing an application or firmware. For example, with regard to a specific game, a game provider may set an input mode that is most appropriate to execute the game and thus recommend the input mode. As another example, the user convenience may be determined based on preferences of a user of the display apparatus 100.

Priority between input modes may be set to provide an input mode with a highest priority as a default input mode, and an interface may be provided to allow selection of another input mode. As another example, the default input mode may be provided based on a predefined rule. As another example, information about an input mode appropriate for an operational situation of the display apparatus 100 may be provided. Accordingly, an initial input mode about an operational situation of the display apparatus 100 may be changed, and a user-convenient input mode may be recommended.

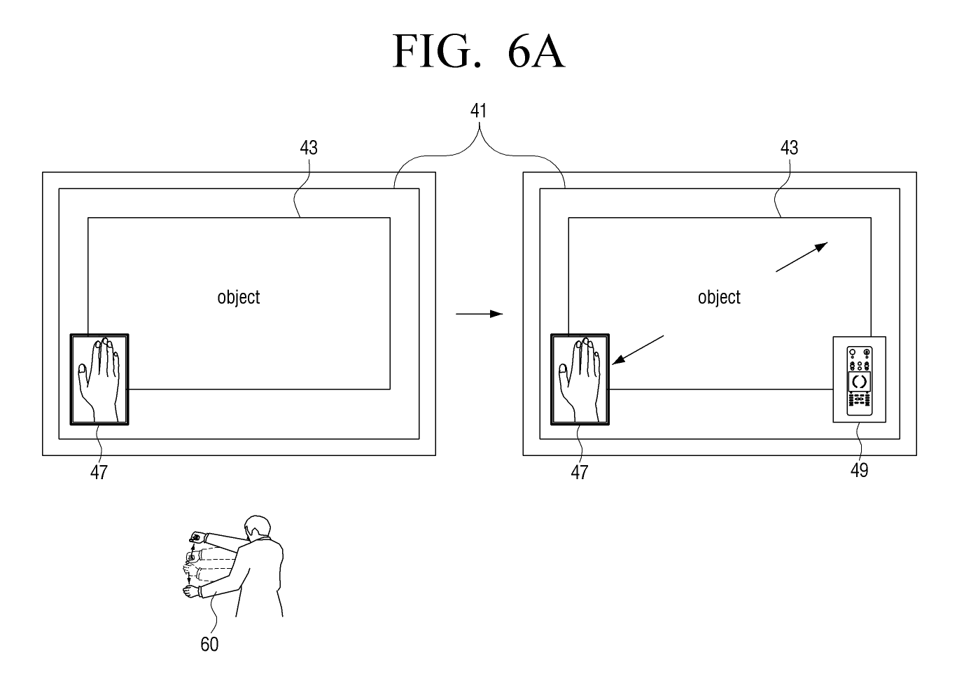

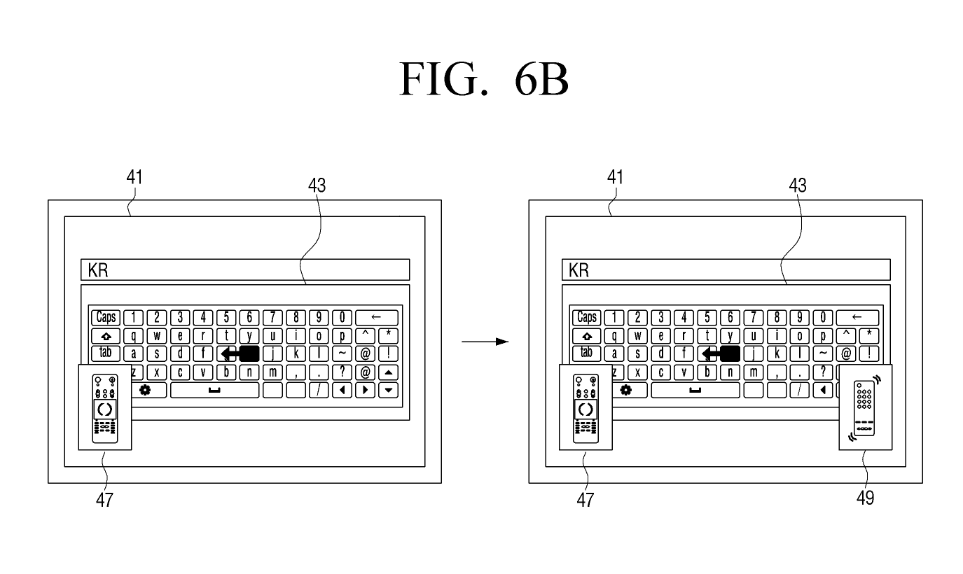

FIG. 6A is a diagram illustrating the display apparatus recommending another input mode available to a user according to an exemplary embodiment.

Referring to FIG. 6A, upon receiving a user input in a default input mode or an input mode selected by a user, the controller 120 may process the input. In FIG. 6A, when the user performs an input 60 for enlarging the object 43 (as illustrated by moving both fists away from each other in opposite directions), the controller 120 may perform an output for enlarging the object 43. In this example, an image indicating that a currently configured input mode is a user gesture input mode is displayed at region 47.

In addition, if another gesture input mode is available to the user, the controller 120 may control the display 110 to display information about another gesture input mode on the screen. In the example of FIG. 6A, information indicating that different input modes for the same output are available is displayed on another region 49 of the screen. In particular, information indicating that a similar gesture input is available via a touchpad of a remote controller is displayed. To input the user gesture the user needs to operate with both hands, however, an accurate operation that the user is requesting may be difficult to detect according to a posture or position of the user. In this case, the same gesture is possible via a touchpad of a remote controller. Accordingly, the user may be capable of more conveniently performing input irrespective of a posture or position of the user via the touch pad of the remote controller. Accordingly, information about another available input mode may be notified to the user and be displayed on another region 49 of the screen.

In FIG. 6A, indication of the user gesture input mode is highlighted in order to emphasize a currently used input mode. For example, the user may be capable of changing the input mode via a user gesture, manipulation of a remote controller, and the like.

FIG. 6B is a diagram of another gesture input mode available to a user according to another exemplary embodiment.

A left portion of FIG. 6B illustrates an example in which a user manipulates a direction key of a remote controller to change a position of a pointer on a display screen (i.e. a remote controller button input mode). In response to an input performed by the user for manipulation of a direction key of the remote controller to change the position of the pointer on a virtual keyboard illustrated on the display screen, the display apparatus 100 may display information indicating that another input mode is available for the same control command on region 49 of the screen. For example, the display apparatus 100 may move a remote controller including a moving sensor in a direction corresponding to the manipulated direction key to display information indicating that the position of the pointer on the virtual keyboard is capable of being changed, at region 49 of the screen.

For example, when the user intends to move the pointer away from a current position of the display screen, and the process is performed by manipulating a direction key, the user may experience inconvenience of manipulating the direction key a plurality of number of times. In this example, the display apparatus 100 may determine an intention of the user and move the remote controller including the moving sensor to the direction key corresponding to the manipulated direction key to display information indicating that the position of the pointer on the virtual keyboard is capable of being changed, at the region 49 of the screen. Accordingly, the display apparatus 100 can recommend another gesture input mode based on the intention of the user.

For example, when the user inputs a specific direction key five times or more within a predetermined period of time, the display apparatus 100 may determine the user intention as moving the pointer away from the current position. In this example, the display apparatus 100 may display an indication that the remote controller including the moving sensor is capable of being used (a remote controller gesture input mode), on one region of the screen.

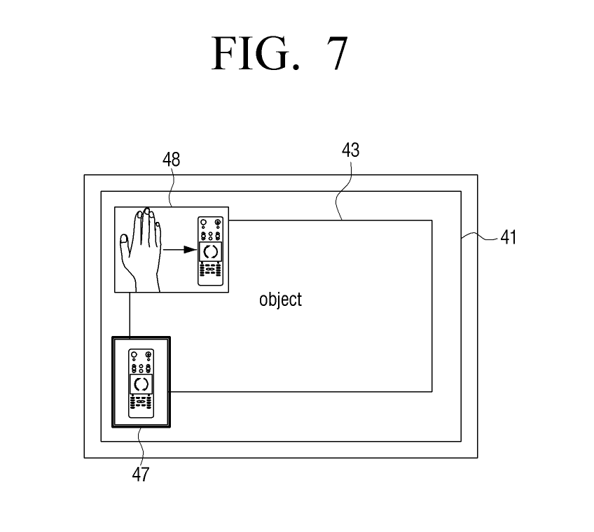

As another example, a user may perform input via a remote controller gesture from the beginning. In this example, when the user tilts a remote controller at a predetermined angle or more with respect to a surface, the display apparatus 100 may enter a remote controller gesture input mode. In addition, the display apparatus 100 may display information indicating how to enter into the remote controller gesture input mode, on one region of the screen. In this case, information indicating that the current input mode is changed to the remote controller gesture input mode may be displayed (refer to the example of FIG. 7).

FIG. 7 is a diagram illustrating the display apparatus indicating a change in an input mode according to an exemplary embodiment.

When the input mode is changed, the controller 120 may control the display to display guide information indicating the change in input mode, on a region of the screen. FIG. 7 illustrates an example in which an input mode is changed to a remote controller touch input mode from a user gesture input mode according to selection of a recommended input mode by the user of the display apparatus 100. In this example, information indicating that an input mode is changed to a remote controller touch input mode from a user gesture input mode is displayed on an upper region 48 of the screen. In addition, a current input mode may also be displayed on another region of the screen. In this example, because the changed input mode is a remote controller touch input mode, information about the remote controller touch input mode is displayed on region 47.

The controller 120 controls the display 110 to perform output based on the received user input. Also, when the display apparatus 100 further includes a sound output unit (not shown), the controller 120 may control a sound output unit to generate and output a beep sound or other sounds.

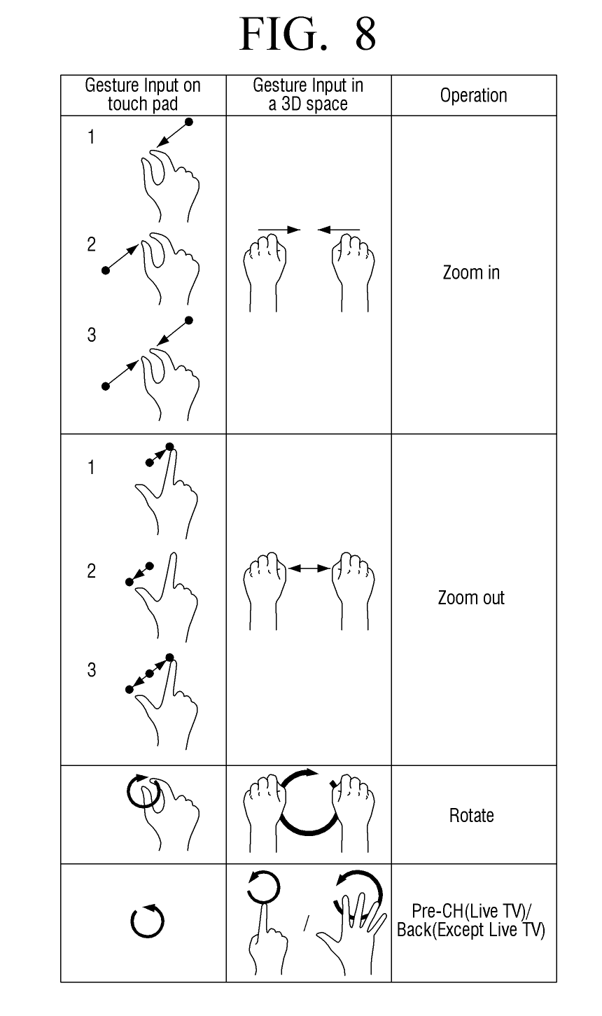

Because gesture input via a touch pad of a remote controller and user gesture input use different inputting methods, mapping between inputs having the same meaning may be helpful. FIG. 8 is a table illustrating methods and operations of possible gesture inputs according to an exemplary embodiment.

As illustrated in FIG. 8, a zoom-in command user gesture may be executed by a user bringing both hands toward a central point. As another example, a zoom-in command may be performed using a touchpad and may be executed by dragging two fingers towards each other while the fingers are in contact with the touchpad. A case in which one of two touch points is moved and the other one is fixed and a case in which both the two points are moved may be treated in the same way.

A zoom-out command user gesture may be executed by a user moving both hands away from each other with respect to a same point. As another example, a zoom-out command may be performed using a touchpad and may be executed by a user dragging two fingers away from each other while the fingers are in contact with the touchpad. A case in which any one of two touch points is moved and the other one is fixed and a case in which both the two points are moved may be treated in the same way.

A rotation command may be used to rotate an object. For example, the rotation command may be used to rotate a picture displayed in a horizontal direction at 90 degrees to display the picture in a vertical direction, or vice versa. A rotation command may be executed by a user gesture of rotating both hands in the same direction (clockwise or counterclockwise) while the hands are a predetermined distance apart. As another example a rotation command may be performed by using a touchpad by rotating one or more fingers in the same direction with respect to a central point of while the fingers are a predetermined distance apart and touching the touch pad.

A back command may be used to return to a previously visited page by a web browser, to cancel execution of an application, to move a file directory to a higher directory, and the like. The back command may be executed by a user rotating fingers clockwise to form a circular path while all the fingers are spread. A command for selecting a previous channel in a television (TV) may be differently defined from the back command. For example, in FIG. 8, a gesture input of rotating one finger clockwise to form a circular path may be defined as a previous channel selection command. Gestures defined in FIG. 8 are purely exemplary and thus it may be possible to define and map other gestures as desired.

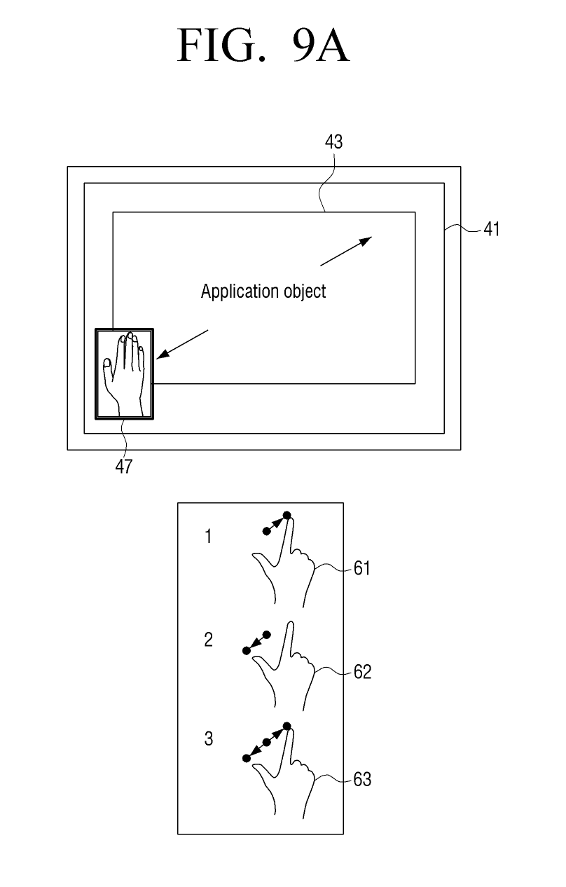

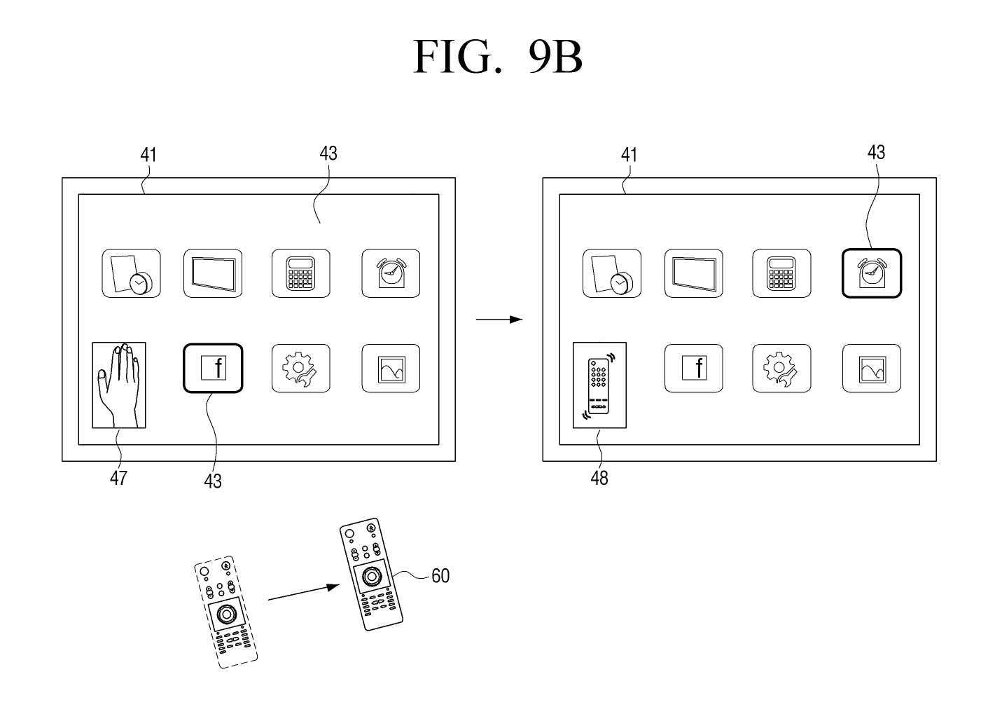

FIG. 9A illustrates an input that is received according to a remote controller touch gesture input mode while a user gesture input mode is set according to an exemplary embodiment, and FIG. 9B illustrates an input that is received according to a remote controller movement gesture input mode while a user gesture input mode is set according to an exemplary embodiment. In these examples, user intuition is considered for conversion of an input mode

Upon receiving an input for a different input mode than an input mode set for the display apparatus 100, the controller 120 may determine whether a user input according to the different input mode is possible. In this example, if the different input is possible, an input mode of the display apparatus 100 may be converted into the different input mode, and the received input may be processed.

In the example of FIG. 9A, the display apparatus 100 sets a user gesture input mode. As described above, the display apparatus 100 may display information about a currently set user gesture input mode and indicate information about other available input modes, for example, information indicating that a touch gesture input via a remote controller is possible. However, without selecting an input mode, the user may attempt to perform input according to an input mode. In the example of FIG. 9A, the user may input a zoom-out gesture on a touchpad of the remote controller without notice.

In this example, the controller 120 may determine whether a gesture input using a touchpad of a remote controller is possible and may analyze the input gesture. Furthermore, the object 43 may be enlarged in response to the input gesture. In addition, an input mode of the display apparatus 100 may be changed to a remote controller touch gesture input mode if it is not already in the remote controller touch gesture input mode. As described above, a case in which only one touch point is moved 61 and 62 and a case in which both the two touch points are moved 63 may be treated in the same way.

In the example of FIG. 9B, the display apparatus 100 may set a user gesture input mode. For example, the display apparatus 100 may display information about a currently set user gesture input mode and indicate information about other available input modes, for example, information indicating that a touch gesture input via a remote controller 60 including a moving sensor is available. However, without selection of another input mode, the user may perform input of moving the remote controller 60.

In this example, the controller 120 may determine whether a gesture input using the movement of the remote controller is possible and may analyze the input gesture. Based on the input gesture, a highlight or point position 43 on the screen 41 may be moved. In addition, an input mode of the display apparatus 100 may be changed to a remote controller movement gesture input mode 48.

The controller 120 may control the display to illustrate a gesture path according to the received user gesture input on a region of the screen. This function allows the user to check a gesture input by the user to provide input guide to the user.

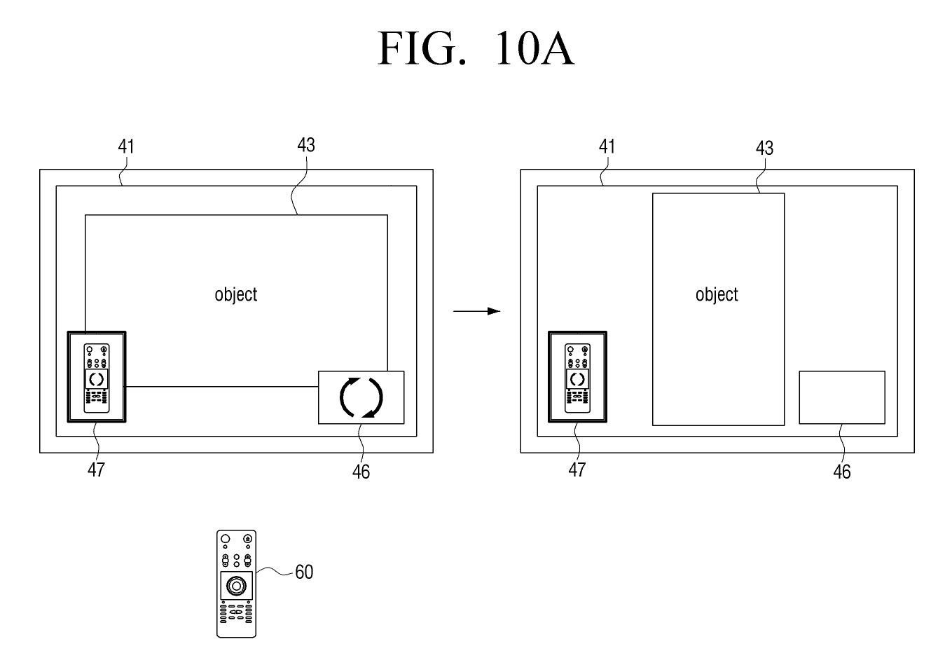

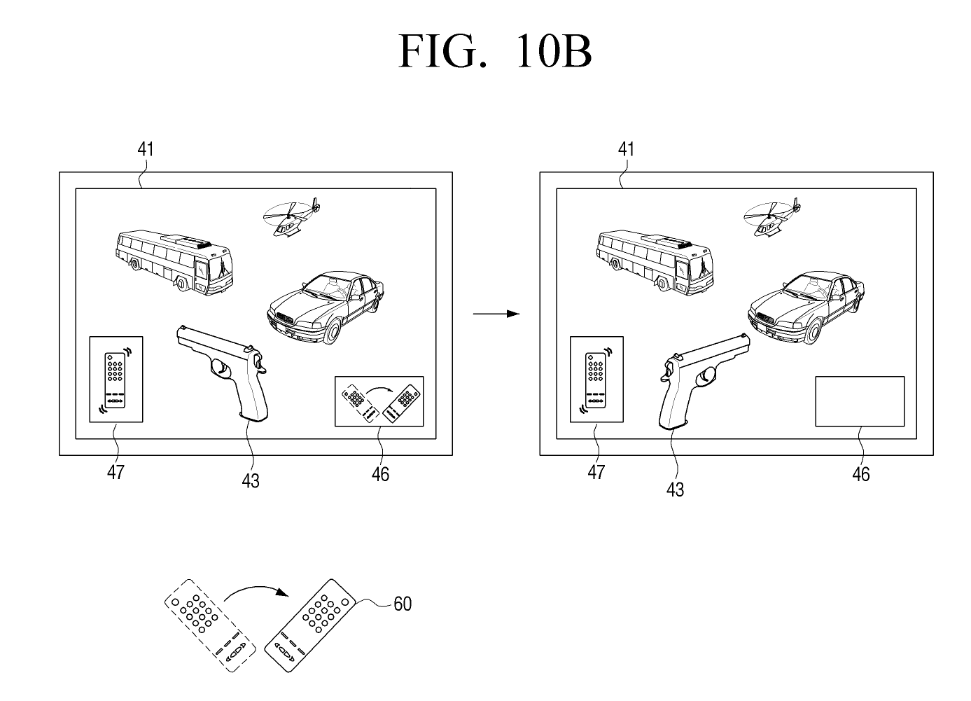

FIG. 10A illustrates the display apparatus displaying a gesture path of movement according to an exemplary embodiment. In FIG. 10A, a user performs a touch gesture input using a remote controller 60. Information about a currently set input mode is displayed at region 47 of a screen, and a path of a touch gesture input is displayed at another region 46 of the screen in the set input mode. In this example, the user performs a gesture input for a rotation command, and in response the object 43 is rotated as illustrated in a right portion of FIG. 10A. When the gesture input is completed, the displayed path of the gesture input may disappear 46.

In the case of a remote controller movement gesture input mode, the controller 120 may control the display illustrate movement of a remote controller according to the received remote controller movement gesture input, on a region of the screen. This function allows the user to check a remote controller movement gesture direction to provide input guide information to the user.

FIG. 10B illustrates the display apparatus displaying a remote controller movement gesture path. In FIG. 10B, a user rotates the remote controller 60 in a right direction to rotate a gun 43 while playing a game. Information about a currently set input mode is displayed on region 47 of the screen, and a path of a remote controller movement gesture input is displayed at another region 46 of the screen in the set input mode. The user performs a gesture input by rotating the remote controller 60, and thus, the object 43 is rotated as illustrated in a right portion of FIG. 10B. When the gesture input is complete, the displayed path of the gesture input disappears 46.

The display apparatus 100 may support writing input via various input modes. For example, the display apparatus 100 may allow a writing input via a touch pad of a remote controller or a user gesture input. When the writing input is possible, a corresponding mode is defined as a writing input mode. For example, each of a user gesture input mode, a remote controller touch gesture input mode, and the like, may have a writing input mode. In the writing input mode, the controller 120 may analyze a user gesture and convert the user gesture into an alphanumeric character. In addition, the converted character may be displayed on a screen.

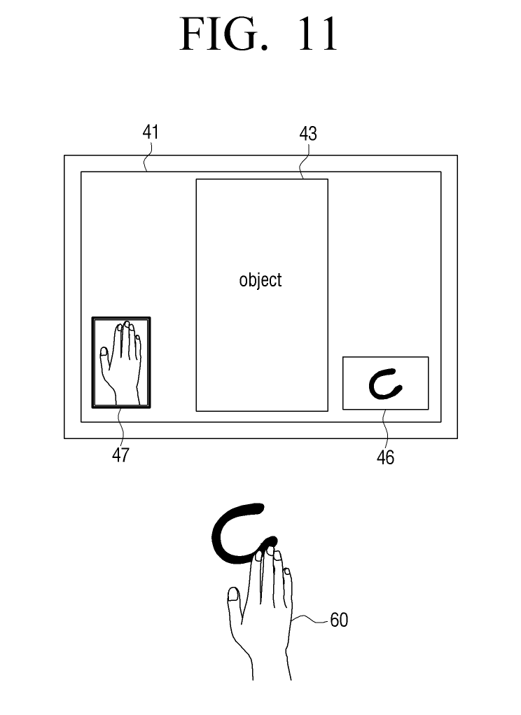

FIG. 11 is a diagram illustrating an operation of a display apparatus set to a writing input mode according to an exemplary embodiment.

In a user gesture input mode, a user inputs a user gesture on a space 47. In this example, a path of the input user gesture may be interpreted as a corresponding character. In FIG. 11, the user performs a gesture corresponding to the letter ‘c’ in a three-dimensional (3D) space, and the controller 120 analyzes a captured image and converts the image into the character ‘c’. In addition, the character ‘c’ is displayed on the screen 46. To insert the character displayed on the screen into an input window, a separate gesture may be performed. As an example, when a user makes a fist, the displayed character ‘c’ may be inserted into the input window.

The writing input mode may be a mode that is identified according to a character and a number. For example, in the case of a character input mode, a gesture is interpreted as a character and in the case of a number input mode, the gesture is interpreted as a number. For example, a number may be interpreted according to a simpler algorithm and a higher number of calculations may be performed to differentiate a character and a number, a character and a number calculation may be differentiated. However, although a character input and a number input may be differentiated by a user interface image to be differentiated from the beginning, the user may not differentiate the character and the number and may input the character and the number, and the controller 120 may differentiate and interpret the character and the number according to character/number algorithms.

As another example, a various input mode may be an operation control mode. If a set gesture input mode is an operation control mode, the controller 120 may analyze the received user gesture input and convert the user gesture input into a control command and control the display apparatus according to the converted control command.

As mentioned, the controller 120 may include a hardware configuration, for example, a micro processing unit (MPU), a central processing unit (CPU), a cache memory, a data bus, and the like. The controller may also include a software configuration such as an operating system (OS), an application for execution of a specific purpose, and the like. The controller 120 may read a control command for an operation of the display apparatus 100 according to a system clock and generate an electrical signal according to the read control command to perform each component of the hardware configuration. For example, the aforementioned input processing method may be executed by an independent application or included in one DSP or FPGA and may be executed.

The display apparatus 100 may include a component for a general calculating apparatus. In addition to the CPU having the aforementioned sufficient control and computational capability, the display apparatus 100 may include a hardware configuration such as a mass auxiliary storage including a hard disk or a Blu-ray disk, an input/output device including a touch screen, a short distance communication module, a wired/wireless communication module including an HDMI, a data bus, and the like.

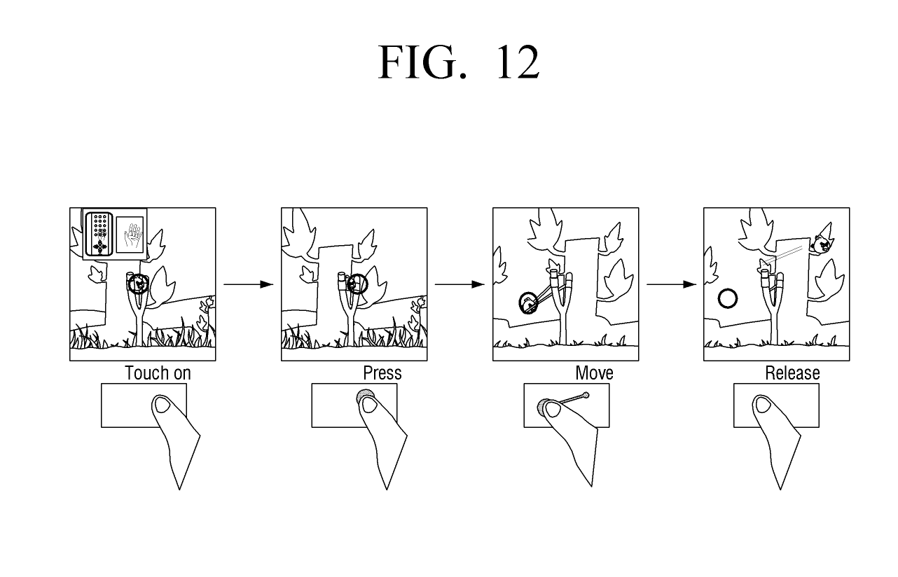

The aforementioned various embodiments of the present invention may be used in various services such as a game, education, Internet, a TV, etc. FIG. 12 is a diagram illustrating a game displayed by the display apparatus that is interacted with by a user gesture input via a touch pad according to an exemplary embodiment.

Referring to FIG. 12, information indicating a video game being currently played on the screen may be manipulated via a touch pad of a remote controller and a user gesture is displayed on an upper portion of a screen of the display apparatus 100. Here, a user selects a touch pad and performs the game. In the example of FIG. 12, a touch point is pressed while being touched via the touch pad of the remote controller instead of the touch screen of the display apparatus 100 to load a shell to be fired by a slingshot. A degree by which a rubber band stretches is determined by a drag input and then a touch is finished to fire the slingshot.

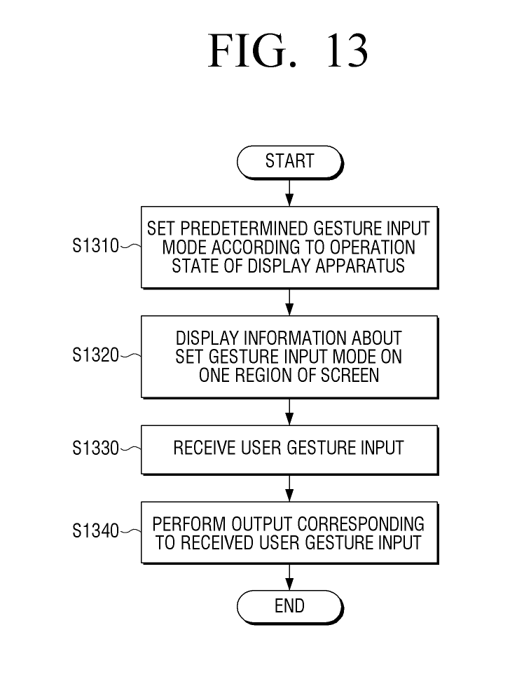

FIG. 13 is a flowchart of a gesture input processing method according to various exemplary embodiments.

Referring to FIG. 13, the gesture input processing method according to an embodiment of the present invention includes setting a gesture input mode according to an operation state of a display apparatus, in S1310, displaying information about the set gesture input mode on a region of a screen, in S1320, receiving a user gesture input, in S1330, and performing output corresponding to the received user gesture input, in S1340.

For example, the setting of the gesture input mode in S1310 may include recommending a gesture input mode according to the operation state of the display apparatus and displaying the gesture input mode on the screen. In response to selection of the displayed gesture input mode being input, the setting may include setting the selected gesture input mode as the input mode.

As another example, the setting of the gesture input mode in S1310, may include, in response to a user input being performed via a predetermined gesture input mode, displaying information about other available gesture input modes on the screen, and setting the gesture input mode in response to selection of the displayed gesture input mode being input.

The gesture input processing method may further include displaying guide information indicating that a gesture input mode is changed, on a region of the screen, in response to the gesture input mode being changed in S1320. For example, the gesture input processing method may further include, in response to a gesture input for a different gesture input mode being received, converting a gesture input mode of the display apparatus into the different gesture input mode. The method may further include displaying a gesture path according to the received user gesture input on the screen in S1330.

The outputting corresponding to the received user gesture input in S1340 may include, in response to the set gesture input mode being a writing input mode, analyzing the received user gesture input and converting the user gesture input into a character, and displaying the converted character on the screen.

As another example, the outputting corresponding to the received user gesture input in S1340 may include, in response to the set gesture input mode being an operational control mode, analyzing the received user gesture input and converting the user gesture input into a control command, and controlling the display apparatus according to the converted control command.

According to various aspects, provided herein is a display apparatus that may receive input from a user using multiple input devices. For example, based on an application selected for execution on the display apparatus, the display apparatus may determine at least one input device for interacting with the application during execution. To assist the user, the display apparatus may output identification information to a display to identify the at least one input device that a user may use for interacting with the application. Accordingly, user convenience of interacting with the display apparatus may be improved when there are multiple input devices capable of being used.

The methods described above can be written as a computer program, a piece of code, an instruction, or some combination thereof, for independently or collectively instructing or configuring a processing device to operate as desired. Software and data may be embodied permanently or temporarily in any type of machine, component, physical or virtual equipment, computer storage medium or device that is capable of providing instructions or data to or being interpreted by the processing device. The software also may be distributed over network coupled computer systems so that the software is stored and executed in a distributed fashion. In particular, the software and data may be stored by one or more non-transitory computer readable recording mediums. The media may also include, alone or in combination with the software program instructions, data files, data structures, and the like. The non-transitory computer readable recording medium may include any data storage device that can store data that can be thereafter read by a computer system or processing device. Examples of the non-transitory computer readable recording medium include read-only memory (ROM), random-access memory (RAM), Compact Disc Read-only Memory (CD-ROMs), magnetic tapes, USBs, floppy disks, hard disks, optical recording media (e.g., CD-ROMs, or DVDs), and PC interfaces (e.g., PCI, PCI-express, WiFi, etc.). In addition, functional programs, codes, and code segments for accomplishing the example disclosed herein can be construed by programmers skilled in the art based on the flow diagrams and block diagrams of the figures and their corresponding descriptions as provided herein.

The aforementioned gesture input processing method may be embedded and provided in a hardware integrated circuit (IC) chip in the form of embedded form such as FPGA or included and embodied in an application or DSP of the display apparatus 100.

According to the aforementioned various embodiments of the present invention, usage information of various input devices may be guided according to an operational state of a display apparatus, thereby enhancing user convenience.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A method of processing a gesture input to a display apparatus, the method comprising:
setting a gesture input mode based on an operational situation of the display apparatus;
displaying information about the set gesture input mode on a screen of the display apparatus; and
in response to receiving an input that corresponds to the set gesture input mode, performing a control operation with respect to the screen.

2. The method of claim 1, wherein the setting the gesture input mode comprises:
recommending a gesture input mode according to the operational situation of the display apparatus and displaying the recommended gesture input mode on the screen; and
in response to selection of the recommended gesture input mode being input, setting the recommended gesture input mode as the gesture input mode.

3. The method of claim 1, wherein the setting of the gesture input mode comprises:
in response to a user input being performed via the gesture input mode, displaying information about the other available gesture input mode on the screen; and
setting the gesture input mode as the other available gesture input mode in response to selection of the other available gesture input mode being input.

4. The method of claim 1, further comprising displaying information indicating that the gesture input mode is changed, in response to the gesture input mode being changed.

5. The method of claim 1, further comprising, in response to a an input for a different gesture input mode from the set input mode being received, determining whether the different gesture input mode is available, and converting the gesture input mode into the different gesture input mode.

6. The method of claim 1, further comprising displaying a recommended movement path of an input device according to the received input on the screen.

7. The method of claim 1, wherein the outputting comprises:
in response to the set gesture input mode being a writing input mode, analyzing the received input, converting the received input into a character, and displaying the converted character on the screen.

8. The method of claim 1, wherein the outputting comprises:
in response to the set gesture input mode being an operational control mode, analyzing the received input, converting the received input into a control command, and controlling the display apparatus according to the converted control command.

9. The method of claim 1, wherein the operational situation of the display apparatus is based on an application that is being executed by the display apparatus.

10. A non-transitory computer readable medium for recording thereon a program for executing the method of claim 1.

11. A display apparatus comprising:
a display;
an input unit configured to receive a gesture input; and
a controller configured to set a gesture input mode according to an operational situation of the display apparatus, display information about the set gesture input mode on a screen of the display, and, in response to receiving an input that corresponds to the set gesture input mode, perform a control operation with respect to the screen.

12. The display apparatus of claim 11, wherein the controller is configured to recommend a gesture input mode according to the operational situation of the display apparatus and display the recommended gesture input mode, and in response to selection of the recommended gesture input mode being input, set the recommended gesture input mode as the gesture input mode.

13. The display apparatus of claim 11, wherein, in response to a user input being performed via the set gesture input mode, the controller is configured to display information about another available input mode on the screen, and set the gesture input mode as the other available gesture input mode in response to selection of the other available gesture input mode being input.

14. The display apparatus of claim 11, wherein the controller is configured to display information indicating that the gesture input mode is changed on the screen, in response to the gesture input mode being changed.

15. The display apparatus of claim 11, wherein, in response to an input for a different gesture input mode from the set gesture input mode being received, the controller is configured to determine if the different gesture input mode is an available gesture input mode, and convert the gesture input mode into the different gesture input mode.

16. The display apparatus of claim 11, wherein the controller is configured to display a recommended movement path of an input device according to the received gesture input on the screen.

17. The display apparatus of claim 11, wherein, in response to the set gesture input mode being a writing input mode, the controller is configured to analyze the received input, convert the received input into a character, and display the converted character on the screen.

18. The display apparatus of claim 11, wherein, in response to the set gesture input mode being an operational control mode, the controller is configured to analyze the received input, convert the received input into a control command, and control the display apparatus according to the converted control command.

19. The display apparatus of claim 11, wherein the operational situation of the display apparatus is based on an application that is being executed by the display apparatus.
